(19) United States
(12) Patent Application Publication
(10) Pub. No.: US 2003/0141013 A1
(43) Pub. Date: Jul. 31, 2003

(54) Label tape and method of its use

(75) Inventor: Ikuo Nakasaka, Tokyo (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Honda Giken Kogyo Kabushiki Kaisha

(21) Appl. No.: 10/316,899

(22) Filed: Dec. 12, 2002

(30) Foreign Application Priority Data
Jan. 31, 2002 (JP) 2002-023075

(51) Int. Cl. B32B 31/00

(52) U.S. Cl. 156/250; 156/277; 428/317.1

(57) ABSTRACT

A simple-structured and inexpensive label tape and a method of its use make it possible to roll up the label tape in the form of a roll even without a release liner, facilitate its handling and permit the label tape to be printed freely. The label tape (1) includes an elongated label base material (2) supporting a continuous row of label units having prints of a label picture. The label tape (1) has an adhesive 3 coated on the back surface. The adhesive remains unadhesive at normal temperatures but restores its adhesive force enough for adhesion when heated. Upon using the label tape (1), a length of the label tape (1), which is a label unit (9), is unrolled and cut with a blade (15) from a roll (7) of the label tape (1), then heated with a heater 3 to heat an adhesive (3) on the back surface of each cut label unit, and thereafter affixed to a product with the adhesive having restored the adhesive force.

### BACKGROUND OF THE INVENTION

1. Field of the Invention

This invention relates to a label tape made of an adhesive material bearing a number of labels, and a method of using the label tape.

2. Description of the Related Art

In general, labels to be affixed to commercial products, etc. have an adhesive (paste) on their back surfaces to facilitate quick labeling operation. In case of a label tape having a number of labels successively aligned in the lengthwise direction, the label tape cannot be rolled in storage because of an adhesive on back surfaces of the labels, and it is annoying to handle the labels before affixing them on products.

There is a known label intended to overcome the inconvenience in handling labels, which is made of an elongated release liner and adhesively holds thereon a plurality of labels in its lengthwise direction (JP9-216615A and others). In this label tape, a release liner easy to separate from an adhesive on back surfaces of the labels is attached to those back surfaces of the labels aligned successively. Therefore, even when the label tape is rolled up, it can be stored in the form of a roll without undesirable sticking between opposed surfaces of their adjacent turns, and permits the respective labels to be sequentially unstuck from the release liner and affixed to certain products.

There is also a proposal of forming a release agent layer on the front surface of a label tape having labels with an adhesive agent layer on their back surfaces without using a release liner (JP9-258663A, JP2001-183979A and others). In the label tape of this type, even when it is rolled up, the release agent layer on the front surface thereof prevents adjacent turns to stick to each other and permits the label tape to be easily released for use.

In case of the former technique using the release liner, the release liner remains as waste after the labels are detached from the tape and affixed on products, and it is against the movement toward the resource saving. Additionally, the release liner results in raising the cost of labels because of the expense for disposal thereof in addition to the cost of its own.

In case of the latter technique not using a release liner, the presence of the release agent layer on front surfaces of labels makes it necessary to form a thermally coloring layer under the release agent layer to enable subsequent printing with a thermal printer, or to carry out printing before forming the release agent layer.

Therefore, this technique needs at least the release agent layer, and involves various inconveniences such as an increase of the cost, restriction to the employable printing technique, and incapability of printing at the site of label-affixing job.

The invention has been made taking account of the problems involved in the conventional techniques, and it object is to provide a simple-structured, low-cost label tape that can be rolled in storage without using a release liner, conveniently handled and printed freely, as well as a method of its use.

### SUMMARY OF THE INVENTION

To accomplish the object, the invention provides a label tape including an elongated label base material having label units aligned in the lengthwise direction and including an adhesive layer formed on a back surface of the label base material, characterized in that the adhesive layer is made of an adhesive agent which is not adhesive at normal temperatures but restores an adhesive force enough for adhesion.

Since the label tape does not use a release liner, it is lowered in cost without the cost of the release liner and the expense for its disposal, and contributes to the resource saving. In addition, since the adhesive coated on back surfaces of the label tape remains unadhesive at normal temperatures, it can be rolled up in storage and can be handled conveniently. The adhesive restores its adhesive force when the back surface of the label tape is heated, and the labels can be affixed to products. Thus the labels can be affixed efficiently.

Label picture on label units of the label tape can be printed either before the label-affixing operation or upon the label-affixing operation.

The label tape according to the invention may have slits between every adjacent label units. With the slits, users can detach individual label units easily and accurately to affix them to products.

The adhesive preferably contains a thermoplastic resin, a solid plasticizer and an adhesive agent in the form of a mixture of their particles. The solid plasticizer may be a material that melts and exhibits an adhesive force at temperatures higher than normal temperatures.

The invention also provides a method of using the label tape. This method of using the label tape, which includes an elongated label base material having label units aligned in the lengthwise direction and includes an adhesive layer formed on a back surface of the label base material, the adhesive layer being made of an adhesive agent which is not adhesive at normal temperatures but restores an adhesive force enough for adhesion, and the label tape being rolled up in the form of a roll, comprises:

unrolling the roll,

cutting a length of each label unit from the unrolled label tape;

heating the adhesive on the back surface of each cut label with a heater to restore an adhesive force; and

adhesively affixing the label unit on a product with the adhesive restoring the adhesive force.

With this method, users can use the label tape in form of a roll while unrolling it. The users can easily restore the adhesive force of the adhesive on the back surface by heating it with a heater, sequentially cut out label units and affix them on products. Thus the users can easily handle the label tape and can enhance their label-affixing operation.

In addition, since the label tape does not include a release liner and alleviates the job of its disposal after exhausting labels, both a reduction of the cost and contribution to the resource saving can be attained.

Printing on label units may be carried out either before rolling up the label tape or after unrolling a roll of the label tape. In the latter case, users can print a label picture on site while unrolling the label tape, cutting a length of each print of the label picture, sequentially heating the adhesive with a heater and affixing them on products. Therefore, the method enables free and convenient printing of the label picture on site, thereby enables general use of the roll of label tape, and therefore contributes to lowering the cost.

### BRIEF DESCRIPTION OF THE DRAWINGS

FIG. 1 is a perspective view that shows a roll of label tape according to an embodiment of the invention;

FIG. 2 is a cross-sectional view of the label tape taken along the II-II line of FIG. 1;

FIG. 3 is a perspective view of a label dispenser employed for using the label tape; and

FIG. 4 is a front elevation of the rough interior structure of the label dispenser.

### DESCRIPTION OF THE PREFERRED EMBODIMENTS

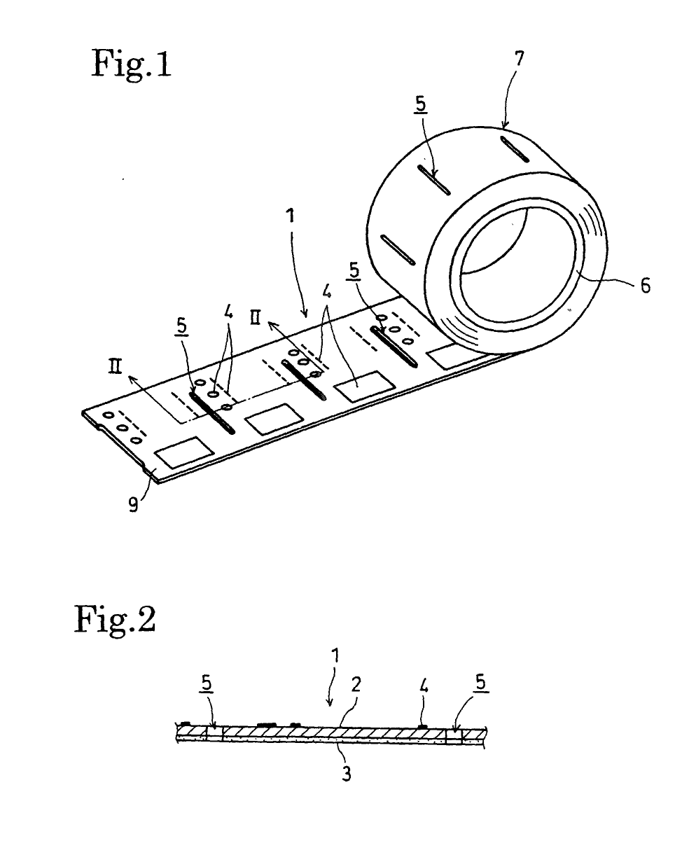

An embodiment of the invention will now be described with reference to FIGS. 1 through 4. As shown in FIGS. 1 and 2, the label tape 1 according to the embodiment includes an elongated label base material 2 made of paper, for example, and the label base material 2 has a series of prints of a label picture 4 printed on its front surface along the lengthwise direction. On the back surface of the label base material 2, it has a coating of a special adhesive 3 that is one of important features of the invention. Each region of the label base material 2 having each print of the label picture 4 constitutes a label unit. The label picture 4 can be printed on respective label units on the label base material 2 by various printing methods.

The adhesive 3 used here remains unadhesive at normal temperatures, but restores its adhesive force when heated. The adhesive may be, for example, EN 900 or ED 950N (both being trade names) from Dainippon Ink and Chemicals, Incorporated of Japan. Adhesives of this kind are called delayed tack adhesives (DLA) and are made of a thermoplastic resin, a solid plasticizer, an adhesive agent and water. The water occupies about a half of the entirety (in weight %), and the relative content of the remainder components, namely thermoplastic resin, solid plasticizer and adhesive agent, is approximately 4:5:1. The thermoplastic resin, solid plasticizer and adhesive agent are contained in the form of a mixture of their particles. A typical thermoplastic resin is acrylic resin. A typical solid plasticizer is hindered phenolic resin. A typical adhesive agent is rosin ester resin. All of these thermoplastic resin, solid plastic resin and adhesive agent have softening temperatures not lower than room temperatures (not lower than 60° C.) and are not adhesive at room temperatures. However, when they are heated to or higher than the melting point of the solid plasticizer (80° C.), the solid plasticizer melts and liquefies, infiltrates into the thermoplastic resin and the adhesive agent. Then the adhesive agent is softened and exhibits adhesive force.

Thereafter, this adhesive agent maintains the adhesive force even when the temperature lowers. Its mechanism will be explained below. When the solid plasticizer is heated to a temperature higher than the melting point and melts, three components, namely thermoplastic resin, solid plasticizer and adhesive agent, mix together. Once they mix together, the solid plasticizer cannot crystallize any more and maintains the adhesive force even when the temperature lowers to or below its melting point. That is, the adhesive force of the solid plasticizer can be maintained if it is prevented from re-crystallization. For this purpose, it is important to keep the surface with the molten and activated solid plasticizer off from human hands or prevent that water or air directly contact the molten and activated surface due to exfoliation of the adhesive surface, for example.

The label tape 1 has formed elongated slits 5 extending across the label tape in boundaries between every adjacent prints of the label picture, that is, in centers of boundaries between every adjacent label units.

The label tape 1 having the above configuration is rolled up on a core 6 as shown in FIG. 1. Since the adhesive 3 coated on the back surface of the label base material 2 is not adhesive at room temperatures, the label tape 1 does not suffer undesirable sticking between opposed surfaces of adjacent turns of the roll even when rolled up on the core. Therefore, the label tape 1 can be unrolled smoothly, and easily stored without sticking to everywhere around it. Thus the tape label 1 can be handled easily and conveniently.

In the instant embodiment, the label tape 1 is rolled up on the core 6 with its front surface having prints of the label picture oriented inside to form a roll 7.

Users can unroll the label tape 1 from the roll 7 while sequentially cutting each label 9 along the slit 5 from the outermost end of the label tape 1, then heating the adhesive agent 3 on the bottom surface to restore the adhesive force, and affix each label 9 on a product with the adhesive force of the adhesive agent 3. Users may carry out these steps manually or may use a label dispenser 10 described below to perform the same steps.

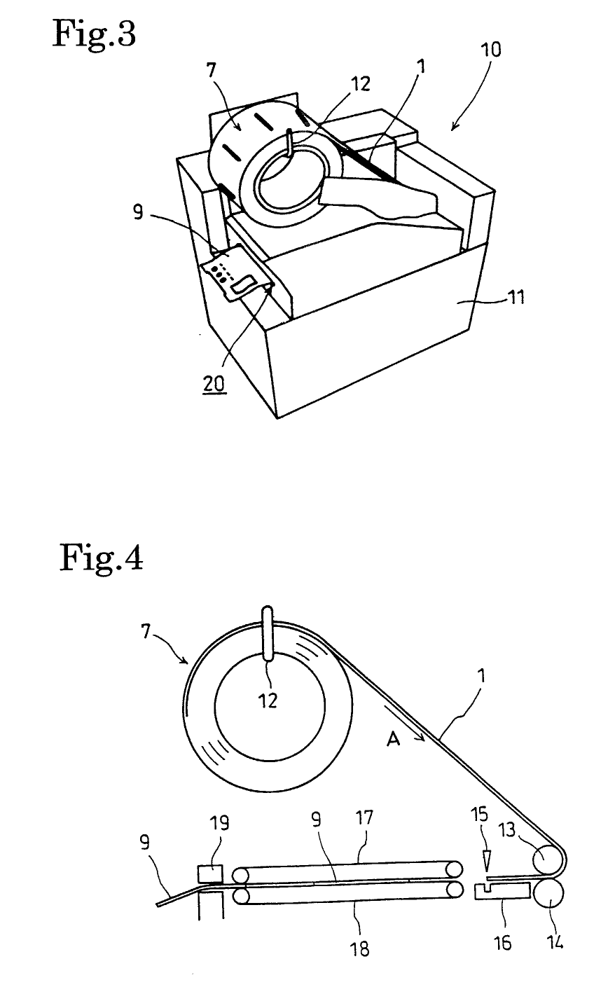

As shown in FIG. 3, the label dispenser 10 includes a machinery located on a board 11. A support rod 12 extends horizontally above the machinery to pivotally support a roll 7 of label tape. The distal end of the support rod 12 is bent upward to prevent the roll 7 from dropping.

FIG. 4 shows a rough configuration of the inner machinery of the label dispenser 10. Diagonally down the roll 7 supported on the support rod 12, a pair of upper and lower dispensing rollers 13, 14 are pivotally supported. The outer end of the label tape 1 unrolled diagonally downward from the roll 7 in the arrow-marked direction A is hung around the upper dispensing roller 13, then sandwiched between the upper and lower rollers 13, 14, and fed out horizontally to the left as viewed in FIG. 4. A cutter having a blade 15 and a blade counter 16 is located near the exit of the dispensing rollers 13, 14. The blade 15 moves toward the blade counter 16 along the slit 5 between the outermost print and the next print of the label picture 4 of the label tape 1 dispensed to a predetermined position, and cuts the outermost label unit from adjacent one. The separated label unit 9 is sandwiched and transported by a pair of upper and lower conveyor belts 17, 18 located downstream of the cutter.

A heater 19 is located at a downstream position of the conveyor belts 17, 18. The label unit 9 transported by the conveyor belts 17, 18 is heated by the heater 19, and the adhesive 3 on its back surface restores the adhesive force.

The label unit 9 may be heated at least from the front or back surface. The heater 19 is located near the exit 20 of the label unit 9 from the label dispenser 10.

The label unit 9 heated by the heater 19 is held such that its most part protrudes outward from the heater 19 with its rear end tightly held between the conveyor belts 17, 18 (see FIGS. 3 and 4). When the protruding label unit 9 is pulled, its read end easily disengaged and taken out from the conveyor belts 17, 18.

As such, the label dispenser 10 automatically performs the steps of unrolling the label tape 1 from the roll 7, then cutting and separating the label unit 9 at the outermost end and heating the adhesive 3 on the back surface, and sequentially supplies the label unit 9, i.e. a single label, which is ready to be adhesively affixed.

When a user gets a single label driven out from the exit 20 of the label dispenser 10, the adhesive 3 on the back surface already restores the adhesive force. Therefore, the user can directly affix the label on a product, and can enhance the label-affixing operation. The label dispenser 10 has a simple and compact structure not requiring much space, and can be carried and used anywhere. Further, since this label tape 1 does not include a release liner, it can save the cost of the release liner and the expense for its disposal, and therefore contributes to cost reduction and resource saving. Since the adhesive 3 coated on the back surface of the label tape 1 is not adhesive at room temperatures, the label tape can be stored in the form of a roll 7 and therefore handled conveniently.

The label dispenser 10 explained above is designed for use with a roll 7 of label tape 7 already printed. However, the label dispenser may include a printing function to be used with a roll of label tape not yet printed so as to perform the steps of unrolling, printing, cutting and heating and to supply labels that a user can directly affix them. In this case, the label tape not yet printed can be stored in the form of a roll for wider use and cost reduction. Since any label picture can be printed later in various kinds of locations for affixing labels, the printer-furnished label dispenser enhances the convenience of the label tape.

Furthermore, the label tape according to the invention having the liner-free surface for printing is simple in structure, inexpensive, available for printing of a label picture any time without being limited in mode of printing, and handled conveniently.

What is claimed is:

1. A label tape including an elongated label base material having label units aligned in the lengthwise direction and including an adhesive layer formed on a back surface of the label base material, wherein the adhesive layer is made of an adhesive agent which is not adhesive at normal temperatures but restores an adhesive force enough for adhesion.

2. A label tape according to claim 1 wherein the label unit has a printed surface.

3. A label tape according to claim 1 wherein the label unit has a surface available for printing.

4. A label tape according to claim 1 wherein a slit is formed in each boundary between adjacent said label units.

5. A label tape according to claim 4 wherein the slit extends over a part of the width of the label tape.

6. A label tape according to claim 1 wherein the adhesive includes particles of a thermoplastic resin, a solid plasticizer and an adhesive agent in form of a mixture thereof.

7. A label tape according to claim 6 wherein the solid plasticizer is a material which melts and exhibits an adhesive force at temperatures higher than normal temperatures.

8. A method of using a label tape which includes an elongated label base material having label units aligned in the lengthwise direction and includes an adhesive layer formed on a back surface of the label base material, the adhesive layer being made of an adhesive agent which is not adhesive at normal temperatures but restores an adhesive force enough for adhesion, and the label tape being rolled up in the form of a roll, comprising the steps of:
unrolling the roll,
cutting a length of each label unit from the unrolled label tape;
heating the adhesive on a back surface of each cut label with a heater to restore an adhesive force; and
adhesively affixing the label unit on a product with the adhesive restoring the adhesive force.

9. A method of using a label tape according to claim 8 wherein the label units are printed before the label tape is rolled up.

10. A method of using a label tape according to claim 8 wherein each label unit is printed after the step of unrolling the roll.

11. A method of using a label tape according to claim 8 further comprising the steps of:
pivotally supporting the roll of the label tape;
unrolling the label base material downward from the roll of the label tape;
feeding the label base material horizontally through dispensing rollers; and
cutting the label base material while feeding it horizontally.

12. A method of using a label tape according to claim 11 wherein the heating is carried out while feeding the label base material horizontally after the cutting.
